(19) United States
(12) Patent Application Publication
(10) Pub. No.: US 2025/0241368 A1
(43) Pub. Date: Jul. 31, 2025

(54) Aerosol Generating Device Comprising Two Heating Plates and Associated Method of Controlling

(71) Applicant: JT International SA, Geneva (CH)

(72) Inventor: Alec Wright, Guildford (GB)

(73) Assignee: JT International SA, Geneva (CH)

(21) Appl. No.: 18/853,858

(22) PCT Filed: Apr. 6, 2023
(86) PCT No.: PCT/EP2023/059135

§ 371 Date: Oct. 3, 2024

(30) Foreign Application Priority Data
Apr. 6, 2022 (EP) 22166981.5

(51) Int. Cl. A24F 40/46; A24F 40/20; A24F 40/57; H05B 3/22

(52) U.S. Cl. CPC A24F 40/46; A24F 40/20; A24F 40/57; H05B 3/22

(57) ABSTRACT

An aerosol generating device configured to operate with a flat-shaped tobacco article includes a flat-shaped heating chamber, the heating chamber being configured to receive the flat-shaped tobacco article and including a first heating plate and a second heating plate forming at least partially opposite walls of the heating chamber, the heating plates being made from different materials having different thermal masses, the thermal mass of the second heating plate being greater than the thermal mass of the first heating plate.

### FIELD OF THE INVENTION

The present invention concerns an aerosol generating device comprising two different heating plates.

Particularly, the aerosol generating device according to the invention is configured to operate with a tobacco article, for example a flat-shaped tobacco article, which comprises for example a solid substrate able to form aerosol when being heated. Thus, such type of aerosol generating devices, also known as heat-not-burn devices, is adapted to heat, rather than burn, the substrate by conduction, convection and/or radiation, to generate aerosol for inhalation.

The present invention also concerns a method for controlling the aerosol generating device.

### BACKGROUND OF THE INVENTION

The popularity and use of reduced-risk or modified-risk devices (also known as vaporisers) has grown rapidly in the past few years as an aid to assist habitual smokers wishing to quit smoking traditional tobacco products such as cigarettes, cigars, cigarillos, and rolling tobacco. Various devices and systems are available that heat or warm vaporizable substances as opposed to burning tobacco in conventional tobacco products.

A commonly available reduced-risk or modified-risk device is the heated substrate aerosol generation device or heat-not-burn device. Devices of this type generate aerosol or vapour by heating an aerosol substrate that typically comprises moist leaf tobacco or other suitable vaporizable material to a temperature typically in the range 150° C. to 350° C. Heating an aerosol substrate, but not combusting or burning it, releases aerosol that comprises the components sought by the user but not the toxic and carcinogenic by-products of combustion and burning. Furthermore, the aerosol produced by heating the tobacco or other vaporizable material does not typically comprise the burnt or bitter taste resulting from combustion and burning that can be unpleasant for the user and so the substrate does not therefore require the sugars and other additives that are typically added to such materials to make the smoke and/or vapour more palatable for the user.

Tobacco articles, usable with such type of aerosol generating devices can take various forms. Some of them can present an elongated stick or any other suitable shape, like for example a flat shape. However, design of a tobacco article is often a trade-off between its aesthetics and efficiency in heating.

Some of known aerosol generating devices operating with tobacco article comprise a heater which consumes a lot of energy to bring the heater up to a predefined temperature and thus to heat the tobacco article to the target temperature.

### SUMMARY OF THE INVENTION

One of the aims of the invention is to provide an aerosol generating device requiring less energy to heat and evaporate the vaporizable material from a tobacco article.

For this purpose, the invention relates to an aerosol generating device configured to operate with a flat-shaped tobacco article and comprising a flat-shaped heating;
the heating chamber being configured to receive the flat-shaped tobacco article and comprising a first heating plate and a second heating plate forming at least partially opposite walls of the heating chamber;
the heating plates being made from different materials having different thermal masses, the thermal mass of the second heating plate being greater than the thermal mass of the first heating plate.

Thanks to these features, it is possible to provide an aerosol generating device requiring less energy to heat and evaporate the vaporizable material from a tobacco article while heating the tobacco article in an optimal way. Particularly, the first heating plate, i.e. the heating plate having less thermal mass, enables to rapidly heat the tobacco article with little energy, allowing a fast puff by a user. The second heating plate having a higher thermal mass allows a homogenous heating of the surface of the tobacco article during the whole vaping session. Additionally, the second heating plate ensures a high thermal penetration into the tobacco article, which enables to generate more vapour as compared to the first heating plate. Thus, the user experience while using the aerosol generating device can be improved.

Using of heating plates having different thermal masses makes it possible to use less energy to heat the tobacco article to a predetermined temperature and to maintain its temperature close to this predetermined temperature, as compared to the case of one or several heating plates having substantially identical thermal masses. Additionally, these heating plates achieve a homogeneous heating during the whole vaping session. Consequently, a combination of heating plates having different thermal masses enables to optimize the heating of the flat-shaped tobacco article.

Each heating plate can present a homogeneous body made from a same material, like as metal, ceramics, etc. In this case, by “thermal mass”, it is understood a property of this material which enables it to store heat. The thermal mass can be equivalent to thermal capacitance or heat capacity corresponding to the ability of a body to store thermal energy. The thermal mass can be measured in J/° C. or J/K. In some cases, the thermal mass can be directly proportional to the mass of the body. In this case, the proportion coefficient is called specific heat capacity.

In some embodiments, at least one heating plate presents a heterogeneous body made of different materials. This body can for example present a homogeneous mixture of different materials. In some embodiments, the mixture of materials can also be heterogeneous. This means that the different materials can be distributed in a heterogeneous manner along the heating plate. In case of a heterogeneous body, by “thermal mass” of such a body, it is understood an overall value of thermal masses of all materials forming this body. This overall value can be for example be determined according to the ratios of the materials forming the body or according to any other suitable manner known per se.

Each heating plate may form or be connected to a resistive element designed to be powered by a power supply. The power supply may be controlled by a controller of the aerosol generating device.

According to some embodiments, each heating plate is arranged to be in contact or to face a tobacco portion of the flat-shaped tobacco article.

For example, each heating plate can be in direct or indirect contact with the tobacco portion of the tobacco article. By “direct contact”, it is understood that no intermediate element extends between the corresponding plate and the tobacco portion. By “indirect contact”, it is understood that an intermediate element (such article wrapper) is interposed between the corresponding plate and the tobacco article. In both cases, the tobacco portion of the tobacco article is heated by conduction.

According to other embodiments, each heating plate is arranged only to face the tobacco portion of the tobacco article, without being in contact with it. In this case, the tobacco portion of the tobacco article is heated by convection.

According to some embodiments, the first heating plate is made of metal and the second heating plate is made of ceramics.

Metal and ceramics present both good physical properties to ensure the operation of the aerosol generating device according to the invention. For example, it is known that ceramics presents a greater value of thermal mass than metal. Thus, the metal heating plate can be heated more rapidly whereas the ceramics heating plate can store more thermal energy and heat more homogeneously the tobacco portion. Depending on different types of ceramics and metals, the ratio between the thermal masses of a ceramic heating plate and of a metal heating plate having the same mass can be comprised between 1 and 5, advantageously between 1 and 3, and in some cases between 1 and 2.

According to some embodiments, the first heating plate forms a thin heating film.

Thanks to these features, the first heating plate can heat the tobacco portion very rapidly so as to ensure a quick pre-heating phase. In this case, the second heater can be made from any other material having a greater thermal mass as for example metal, ceramics, etc.

According to some embodiments, further comprising a controller configured to power the first heating plate according to a first heating profile and the second heating plate according to a second heating profile different from the first heating profile.

Thanks to these features, it is possible to control the heating of the tobacco portion carried out by different heating plates using different heating profiles. Each heating profile can be chosen based on the nature of the heating plate and notably, based on the thermal mass of each heating plate. Thus, the heating of the tobacco portion can be optimized according to the different thermal masses of the heating plates.

According to some embodiments, each heating profile comprises an initial segment wherein the corresponding heating plate is powered.

The initial segment can thus include a pre-heating phase of the tobacco portion and according to some embodiments, at least a part of the vaping phase. During this initial segment, both heating plates can be powered according to a maximum power value. According to other embodiments, at least one heating plate can be powered within the initial segment according to a value less than the maximum power value. This value can for example be comprised between 10% and 90% of the maximum value.

According to some embodiments, the initial segment ends upon expiring a predetermined time interval or upon achieving by the second heating plate a predetermined temperature.

Hence, the border of the initial segment of the second heating plate can be formed by a time threshold or a temperature threshold.

The time threshold can be determined empirically. It can for example correspond to an overall duration needed for the second heating plate to achieve a predetermined temperature. The predetermined temperature corresponds to the temperature when the tobacco portion starts to generate aerosol.

The temperature threshold can correspond to the predetermined temperature. The temperature of the second heating plate can be measured by an appropriate temperature sensor arranged in the neighbourhood of the second heating plate. The temperature sensor can be connected directly to the controller.

After the end of the initial segment, the first heating profile can comprise decreasing of the power supply of the first heating element, until for example achieving a substantially zero value. Thus, after the initial segment, only the second heating plate may be powered according to the second heating profile. In other words, after the initial segment, the first heating plate can be switched off and only the second heating plate can be used to heat the tobacco portion of the tobacco article.

According to some embodiments, the duration of the predetermined time interval is comprised between 50 and 70 seconds and is substantially equal to 60 seconds and the predetermined temperature is comprised between 260° C. and 300° C. and is substantially equal to 280° C.

This duration is particularly adapted to ensure a pre-heating of the second heating phased until the predetermined temperature. As mentioned above, said predetermined temperature can correspond to the temperature allowing aerosol generation by the tobacco portion of the tobacco article.

According to some embodiments, each heating profile further comprises a secondary segment;
the secondary segment of the first heating profile comprising turning off the powering of the corresponding heating plate; and
the secondary segment of the second heating profile comprising powering of the corresponding heating plate.

The secondary segment can thus correspond to the part of the vaping phase which is not included in the initial segment. The vaping phase is carried out to generate vapour while user puffs.

As explained above, during the secondary segment, the first heating element can be switched off so as only the second heating element is powered. The greater thermal mass of the second heating plate makes it possible to heat homogeneously the tobacco portion during the vaping phase. Thus, aerosol is generated homogeneously during the whole vaping phase and the whole external area of the tobacco portion can be heated. This avoids wasting of the vaporizable material in the under-heated regions which can for example correspond to peripheral regions in the conventional aerosol generating devices.

The invention also relates to a method for controlling comprising heating of each heating plate according to a heating profile determined based the thermal mass of this heating plate.

### BRIEF DESCRIPTION OF THE DRAWINGS

The invention and its advantages will be better understood upon reading the following description, which is given solely by way of non-limiting example and which is made with reference to the appended drawings, in which:

FIG. 1 is a perspective view of an aerosol generating assembly, the aerosol generating assembly comprising an aerosol generating device according to the invention and a tobacco article usable with the aerosol generating device;

FIG. 2 is a perspective view of the tobacco article of FIG. 1;

FIG. 3 is a partial cross-sectional view of the aerosol generating assembly of FIG. 1 according to plane III; and

FIG. 4 is a graph showing the operation of the aerosol generating assembly of FIG. 1.

### DETAILED DESCRIPTION OF THE INVENTION

Before describing the invention, it is to be understood that it is not limited to the details of construction set forth in the following description. It will be apparent to those skilled in the art having the benefit of the present disclosure that the invention is capable of other embodiments and of being practiced or being carried out in various ways.

The expression “substantially equal to” is understood hereinafter as an equality at plus or minus 10% and preferably at plus or minus 5%.

As used herein, the term “aerosol generating device” or “device” may include a vaping device to deliver an aerosol to a user, including an aerosol for vaping, by means of a heater element explained in further detail below. The device may be portable. “Portable” may refer to the device being for use when held by a user. The device may be adapted to generate a variable amount of aerosol, e.g. by activating the heater element for a variable amount of time (as opposed to a metered dose of aerosol), which can be controlled by a trigger. The trigger may be user activated, such as a vaping button and/or inhalation sensor. The inhalation sensor may be sensitive to the strength of inhalation as well as the duration of inhalation to enable a variable amount of vapour to be provided (so as to mimic the effect of smoking a conventional combustible smoking article such as a cigarette, cigar or pipe, etc.). The device may include a temperature regulation control to drive the temperature of the heater and/or the heated aerosol generating substance (aerosol pre-cursor) to a specified target temperature and thereafter to maintain the temperature at the target temperature that enables efficient generation of aerosol.

As used herein, the term “aerosol” may include a suspension of vaporizable material as one or more of: solid particles; liquid droplets; gas. Said suspension may be in a gas including air. Aerosol herein may generally refer to/include a vapour. Aerosol may include one or more components of the vaporizable material.

As used herein, the term “vaporizable material” or “precursor” may refer to a smokable material which may for example comprise nicotine or tobacco and an aerosol former. Tobacco may take the form of various materials such as shredded tobacco, granulated tobacco, tobacco leaf and/or reconstituted tobacco. Suitable aerosol formers include: a polyol such as sorbitol, glycerol, and glycols like propylene glycol or triethylene glycol; a non-polyol such as monohydric alcohols, acids such as lactic acid, glycerol derivatives, esters such as triacetin, triethylene glycol diacetate, triethyl citrate, glycerin or vegetable glycerin. In some embodiments, the aerosol generating agent may be glycerol, propylene glycol, or a mixture of glycerol and propylene glycol. The substrate may also comprise at least one of a gelling agent, a binding agent, a stabilizing agent, and a humectant.

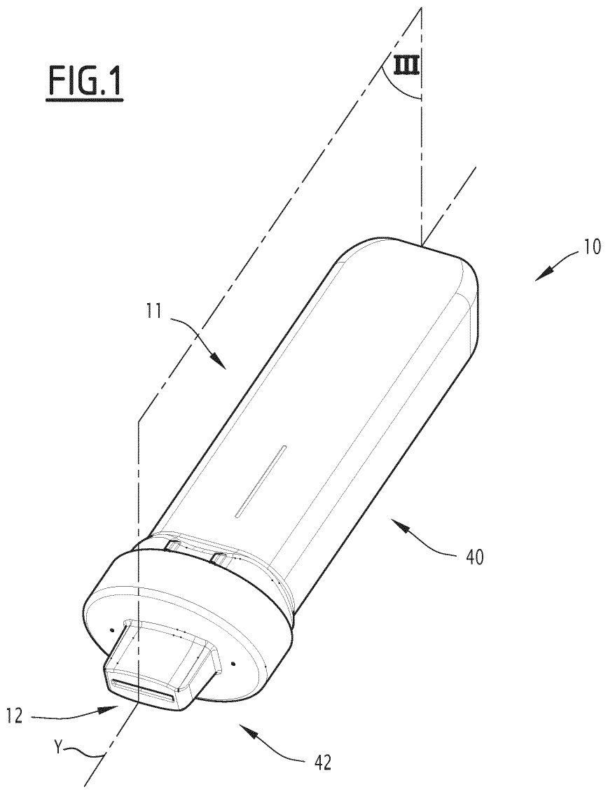

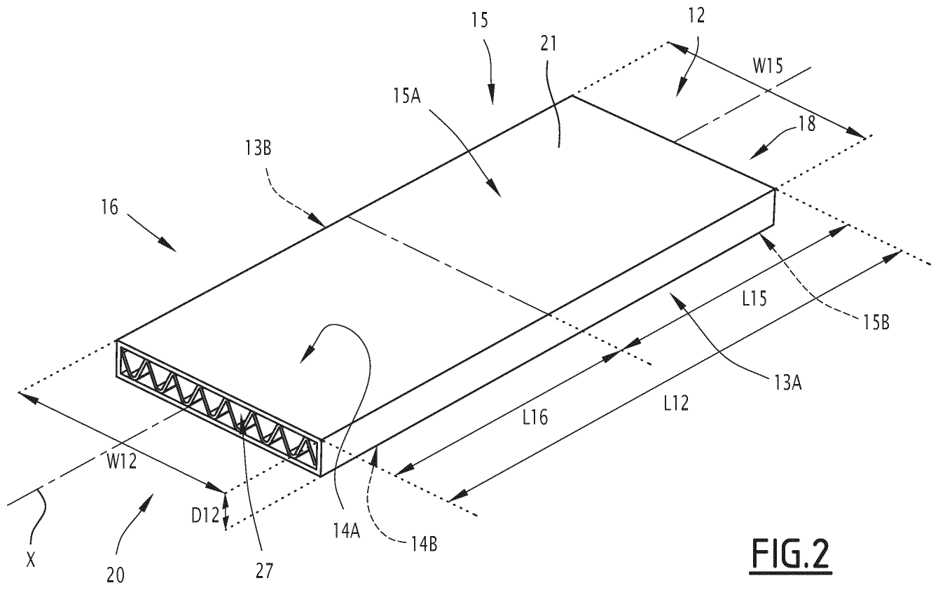

FIG. 1 shows an aerosol generating assembly 10 comprising an aerosol generating device 11 and a tobacco article 12. The aerosol generating device 11 is intended to operate with the tobacco article 12 which is shown in more detail in FIG. 2.

In the example of this FIG. 2, the tobacco article 12 is a flat-shaped tobacco article presenting for example a flat-shaped cuboid extending along an article axis X and having external dimensions L12×W12×D12. In a typical example, the length L12 of the article 12 according to the article axis X equals substantially to 33 mm while its width W12 and depth D12 are substantially equal respectively to 12 mm and 1.2 mm. According to different examples, the values L12, W12 and D12 can be selected within a range of +/−40%, for example. The depth D12 of the tobacco article 12 is formed by a pair of parallel walls 13A, 13B, called hereinafter narrow walls 13A, 13B, and the width W12 of the tobacco article 12 is formed by a pair of parallel walls 14A, 14B, called hereinafter wide walls 14A, 14B. In some embodiments, the edges between the wide and narrow walls 13A, 13B, 14A, 14B can be rounded. According to other embodiments of the invention, the tobacco article 12 can have any other suitable flat shape and/or external dimensions. According to still other embodiments, the tobacco article 12 can present any other suitable shape, as for example a stick shape.

The tobacco article 12 comprises a tobacco portion 15 and a mouthpiece portion 16 arranged along the article axis X. The tobacco portion 15 may for example be slightly longer than the mouthpiece portion 16. The tobacco portion 15 is formed by parallel walls 15A, 15B which are parts of the wide walls 14A, 14B of the tobacco article 12. For example, the length L15 of the tobacco portion 15 according to the article axis X may be substantially equal to 18 mm. The width W15 of the tobacco portion 15 is equal to the width W12 of the tobacco article 12. The length L16 of the mouthpiece portion 16 according to the article axis X may be substantially equal to 15 mm. The tobacco portion 15 defines an abutting end 18 of the article 12 and the mouthpiece portion 16 defines a mouth end 20 of the article 12. The tobacco portion 15 and the mouthpiece portion 16 may be fixed one to the other by a wrapper 21 extending around the substrate axis X. The wrapper 21 forms the narrow and wide walls 13A, 13B, 14A, 14B of the tobacco article 12. In some embodiments, the wrapper 21 is formed from a same wrapping sheet. In some other embodiments, the wrapper 21 is formed by separate wrapping sheets wrapping separately the portions 15, 16 and fixed one to the other by any other suitable mean. The wrapper 21 may, for example, comprise paper and/or non-woven fabric and/or aluminum foil. The wrapper 21 may be porous or air impermeable and forms a plurality of airflow channels extending inside the article 12 between the abutting end 18 and the mouth end 20.

The mouthpiece portion 16 comprises a core 27 intended to act for example as a cooler to cool slightly the vapour before it is inhaled by the user. The core 27 may comprise for this purpose for example corrugated paper. The core 27 may be formed through an extrusion and/or rolling process into a stable shape. Advantageously, the core 27 is arranged inside the mouthpiece portion 16 to be entirely in contact with the internal surface of the wrapper 21 delimiting this mouthpiece portion 16.

The tobacco portion 15 comprises a vaporizable material and is intended to be heated by a heating chamber, as it will be explained in further detail below.

Referring again to FIG. 1, the aerosol generating device 11 comprises a device body 40 extending along a device axis Y and a mouthpiece 42. According to the example described below, the mouthpiece 42 and the device body 40 form two different pieces. Particularly, according to this example, the mouthpiece 42 is designed to be fixed on a fixing end of the device body 40.

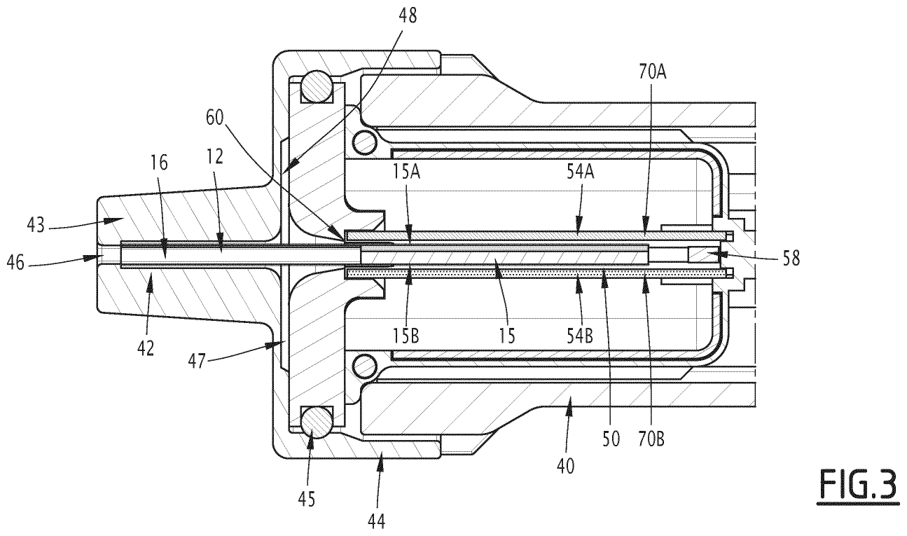

As it is shown in FIG. 3, the mouthpiece 42 comprises a central part 43 and a peripheral part 44 extending around the central part 43. The peripheral part 44 defines for example a collar covering partially an external surface of the device body 40 when the mouthpiece 42 is fixed on the fixing end of the device body 40. For example, the peripheral part 44 can be designed to cooperate with a gasket 45 arranged on the fixing end of the device body 40 in order to seal the space formed between the peripheral part 44 and the external surface of the device body 40. The peripheral part 44 also defines an intermediate portion extending for example transversally to the device axis Y and forming a transition between the central part 43 of the mouthpiece 42 and the collar defined by the peripheral part 44. The central part 43 of the mouthpiece 42 defines a through hole 46 adapted to receive at least partially the tobacco article 12. Particularly, the through hole 46 can be adapted to receive at least a part of the mouthpiece portion 16 of the tobacco article 12 as it is shown in FIG. 3. Advantageously, the through hole 46 can be adapted to fit tightly the mouthpiece portion 16 of the tobacco article 12 so as to avoid or minimise flow leakage between a wall delimiting the through hole 46 and an external surface of the tobacco article 12. In some embodiments, the tobacco article 12 can be retained for example by friction in the through hole 46. In this case, it is possible for example to insert first the mouthpiece portion 16 of the tobacco article 12 inside the through hole 46 and when fix both elements on the fixing end of the device body 40.

As it is also shown in FIG. 3, an inner volume 47 is formed between an inner surface 48 of the mouthpiece 42 and the fixing end of the device body 40. This inner volume 47 is crossed by the tobacco article 12 when it is inserted inside the device body 40. For example, the tobacco article 12 can divide the inner volume 47 in two symmetric parts.

The device body 40 delimits an internal space of the device 11 receiving various elements designed to carry out different functionalities of the device 11. This internal space can for example receive a battery for powering the device 11, a controller for controlling the operation of the device 11, a flat-shaped heating chamber 50 (hereinafter “heating chamber 50”) for heating the tobacco portion 15 of the tobacco article 12, etc. Among these elements, only the flat-shaped heating chamber 50 will be explained in further detail in reference to FIG. 3.

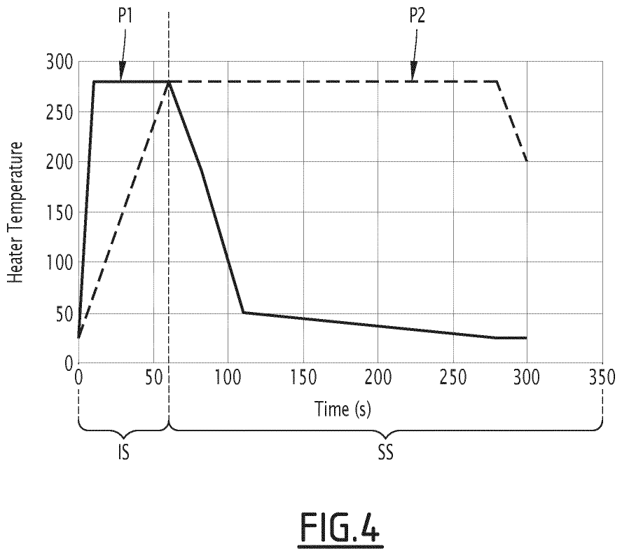

Particularly, as it is shown in this FIG. 3, the heating chamber 50 is configured to receive the tobacco article 12. The heating chamber 50 has a flat shape adapted to receive at least the tobacco portion 15 of the tobacco article 12 and in some cases, at least a part of the mouthpiece portion 16. As the tobacco article 12, the heating chamber 50 may also form a cuboid shape extending along the device axis Y and comprising a pair of parallel narrow walls 53A, 53B (shown in FIGS. 4) extending along the device axis Y, a pair of parallel wide walls 54A, 54B extending also along the device axis Y and a bottom wall 58 adjacent to each of said walls and extending perpendicularly to the device axis Y. The bottom wall 58 forms thus a closed end of the chamber 50. Opposite to the bottom wall 58, the heating chamber 50 defines an opening configured to receive the tobacco article 12 so as the corresponding wide walls 14A, 14B of the tobacco article 12 face the corresponding wide walls 54A, 54B of the heating chamber 50, the corresponding narrow walls 13A, 13B of the tobacco article 12 face the corresponding narrow walls 53A, 53B of the heating chamber 50 and the abutting end 18 of the tobacco article 12 abuts against the bottom wall 58 or at least a rib extending from this bottom wall 58. Alternatively, the abutting end 18 faces the bottom wall 58 without being in contact with it. The flat-shaped heating chamber 50 is thus configured to receive the tobacco article 12 so as the narrow wall 13A (respectively 13B) of the tobacco article 12 faces the narrow wall 53B (respectively 53A) of the heating chamber 50, and the wide wall 14A (respectively 14B) of the tobacco article 12 faces the wide wall 54B (respectively 54A) of the heating chamber 50. The facing wide walls 14A, 14B, 54A, 54B and the facing narrow walls 13A, 13B, 53A, 53B can be in contact one with the other or spaced one from the other.

In the example shown in FIG. 3, the heating chamber 50 comprises a first heating plate 70A and a second heating plate 70B forming at least partially opposite walls of the heating chamber 50. The opposite walls are for example the wide walls 54A, 54B of the heating chamber 50. Each heating plate 70A, 70B is designed to be in contact with or face the tobacco portion 15 of the tobacco article 12. In particular, each heating plate 70A, 70B is designed to be in contact with or face a respective wide wall 15A, 15B of the tobacco article 15. In the example shown on FIG. 3, each heating plate 70A, 70B faces a respective wide wall 15A, 15B of the tobacco article 15 and a gap is defined between the heating plate 70A, 70B and said respective wide wall 15A, 15B of the tobacco article 12. The gap is for example inferior or equal to 0.1 millimeters (mm).

In the example of FIG. 3, the heating plates 70A, 70B have substantially the same dimensions. Additionally, each heating plate 70A, 70B is designed to extend along the whole area of the tobacco portion 15. In other words, the length of each heating plate 70A, 70B is at least equal to the length L15 of the tobacco portion 15 and the width of each heating plate 70A, 70B is at least equal to the width W15 of the tobacco portion 15. According to a specific example shown in FIG. 3, the length of each heating plate 70A, 70B is greater than the length L15 of the tobacco portion 15. Thus, each heating plate 70A, 70B protrudes from both ends of the tobacco portion 15 defined along the device axis Y. This ensures a proper heating of the ends of the tobacco portion 15 defined along the device axis Y. The depth of each heating plate 70A, 70B depends on the dimensions of the tobacco article 15. For example, the depth of each heating plate 70A, 70B is greater or equal to 0.25 mm and less than or equal to 0.75 mm. As also shown in FIG. 3, the tobacco portion 15 is sandwiched between the two heating plates 70A, 70B.

According to another embodiment, the heating plates 70A, 70B have different dimensions.

According to the invention, the heating plates 70A, 70B are made from different materials having different thermal masses, so as the thermal mass of the second heating plate 70B is greater than the thermal mass of the first heating plate 70A. For example, the first heating plate 70A is made from metal, like copper, and the second heating plate 70B is made from ceramics. Additionally, according to different embodiments, each heating plate 70A, 70B can form itself a resistive element or be arranged in contact with a resistive element. Such a resistive element is connected to the controller and can for example form a thin heating film known as such. In the further description, by powering a heating plate, it is understood powering of the resistive element associated with the respective heating plate 70A, 70B.

The controller is configured to control the operation and particularly the powering of each heating plate 70A, 70B. Particularly, the controller is configured to power the first heating plate 70A according to a first heating profile and the second heating plate 70B according to a second heating profile.

An example of these heating profiles is shown in FIG. 4 where the reference P1 designates the first heating profile and the reference P2 designates the second heating profile. As it is shown in this Figure, each heating profile P1, P2 includes an initial segment IS and a secondary segment SS.

According to an embodiment of the invention, the initial segment IS corresponds to a pre-heating phase and the secondary segment SS corresponds to a vaping phase of the aerosol generating device 11. According to another embodiment, the initial segment IS includes the pre-heating phase and a part of the vaping phase. In other words, according to this last embodiment, the initial segment IS extends beyond the pre-heating phase. This last embodiment is shown in FIG. 4 where the pre-heating phase lasts between 10 and 20 seconds until the first heating plate 70A achieves a predetermined temperature (280° C. in the example of this figure) whereas the initial segment IS extends beyond the pre-heating phase.

As it is shown in FIG. 4, during the initial segment IS, both heating plates 70A, 70B are powered. According to different embodiments of the invention, these heating plates 70A, 70B can be powered according to their maximum power value or at least one of them, is powered according to a reduced power value. The reduced power value can be comprised between 10% and 90% of the maximum power value.

The end of the initial segment can be determined by either a time threshold or a temperature threshold. For example, the duration of the initial segment can be limited by a time threshold comprised between 50 and 70 seconds. This time threshold can for example be substantially equal to 60 seconds. Alternatively, a temperature threshold relative to the temperature of the tobacco portion or the temperature of the first heating plate or the temperature of the second heating plate is used. In the example of FIG. 4, a threshold relative to the temperature of the second heating plate is used. Thus, according to this example, the end of the initial segment corresponds to the moment when the second heating plate 70B achieves a predetermined temperature. This predetermined temperature can for example be comprised between 260° C. and 300° C. and is substantially equal to 280° C. According to this embodiment, in order to measure the temperature of the second heating plate 70B, a temperature sensor can be arranged in the neighborhood of this heating plate 70B and can for example be connected directly to the controller.

According to other embodiments, any other parameter relative to the operation of at least one of the heating plates 70A, 70B can be used to determine the end of the initial phase. Thus, for example, a parameter characterizing the electrical current passing through at least one of the heating plates 70A, 70B, as for example consumed electrical power from the beginning of the initial segment IS, can be used.

As it is shown in FIG. 4, during the secondary segment SS, only the second heating plate 70B is powered to maintain its temperature around the predetermined temperature whereas the first heating plate 70A is switched off. Thus, as it is shown in FIG. 4, the temperature of the first heating plate 70A is decreasing during the whole secondary segment SS. Alternatively, the first heating plate 70A can be switched on at least within some time intervals in the secondary segment SS. These time intervals can be defined in predetermined moments of the secondary segment SS or according for example to the temperature of the second heating plate 70B.

According to the invention, the method for controlling the aerosol generating device 11 comprises heating of each heating plate 70A, 70B according to the corresponding heating profile. As mentioned above, for this purpose, the controller of the device 11 controls powering of these heating plates 70A, 70B according to the corresponding heating profiles.

1. An aerosol generating device configured to operate with a flat-shaped tobacco article and comprising a flat-shaped heating chamber;
the heating chamber being configured to receive the flat-shaped tobacco article and comprising a first heating plate and a second heating plate forming at least partially opposite walls of the heating chamber;
the heating plates being made from different materials having different thermal masses, the thermal mass of the second heating plate being greater than the thermal mass of the first heating plate.

2. The aerosol generating device according to claim 1, wherein each heating plate is arranged to be in contact with or to face a tobacco portion of the flat-shaped tobacco article.

3. The aerosol generating device according to claim 1, wherein the first heating plate is made of metal and the second heating plate is made of ceramics.

4. The aerosol generating device according to claim 1, wherein the first heating plate forms a heating film.

5. The aerosol generating device according to claim 1, further comprising a controller configured to power the first heating plate according to a first heating profile and the second heating plate according to a second heating profile different from the first heating profile.

6. The aerosol generating device according to claim 5, wherein each heating profile comprises an initial segment wherein the corresponding heating plate is powered.

7. The aerosol generating device according to claim 6, wherein, in each heating profile, the initial segment ends upon a predetermined time interval expiring or upon achieving by the second heating plate a predetermined temperature.

8. The aerosol generating device according to claim 7, wherein, in each heating profile:
the duration of the predetermined time interval is between 50 and 70 seconds;
the predetermined temperature is between 260° C. and 300° C.

9. The aerosol generating device according to claim 6, wherein each heating profile further comprises a secondary segment;
the secondary segment of the first heating profile comprising turning off the powering of the first heating plate; and
the secondary segment of the second heating profile comprising powering of the second heating plate.

10. A method for controlling the aerosol generating device according to claim 1, comprising heating each heating plate according to a heating profile determined based the thermal mass of the respective heating plate.

11. The aerosol generating device according to claim 7, wherein, in each heating profile:
the duration of the predetermined time interval is substantially equal to 60 seconds;
the predetermined temperature is substantially equal to 280° C.
